(19) United States
(12) Patent Application Publication
(10) Pub. No.: US 2010/0246335 A1
(43) Pub. Date: Sep. 30, 2010

(54) Analog Timepiece with Perpetual Calendar

(76) Inventor: Tai Wai LUK, Hong Kong (HK)

Correspondence Address: Tsz Lung Yeung, 333 W. Garvey Avenue, Suite B 586, Monterey Park, CA, 91754, US

(21) Appl. No.: 12/412,349

(22) Filed: Mar. 26, 2009

(51) Int. Cl. G04B 19/24

(52) U.S. Cl. 368/28

(57) ABSTRACT

An analog timepiece includes a casing, a time indicating device, a quartz driving unit, and a perpetual calendar arrangement. The perpetual control unit is arranged to create an internal time keeping such that the perpetual control unit is adapted to maintain an accurate current time and date, wherein the time indicating device is synchronized with the current time and date as maintained by the perpetual control unit so that the time indicating device is arranged to indicate a time which corresponds with the time internally kept by the perpetual control unit, wherein the perpetual control unit is arranged to display at least one of day information, weekday information, month information and year information by the time indicating device, in such a manner that the corresponding day information, the weekday information, the month information and the year information are automatically adjusted according to the time internally maintained through the perpetual control unit.

### BACKGROUND OF THE PRESENT INVENTION

1. Field of Invention

The present invention relates to an analog timepiece, and more particularly to an analog watch or clock with a perpetual calendar which does not requires a user to manually adjust date information.

2. Description of Related Arts

Generic rotor driven quartz movement watches have long been widely utilized all over the world. These watches are very economical to produce and purchase and have a huge demand and supply in various markets. Generally speaking, there exist three kinds of generic rotor driven quartz movement watches in the market. The first kind of these watches has a single rotor which is arranged to drive three hands (i.e. a second indicating hand, a minute indicating hand and a hour indicating hand) to rotate for indicating current time. The watch generally comprises a control unit utilized for generating a pulse (or multiple pulses) every single second so as to drive the second indicating hand to rotate a corresponding angle on a time chart. The rotational movement of the second indicating hand then drives the minute indicating hand to rotate as well, wherein the rotational movement of the minute indicating hand drives the hour indicating hand to rotate. This first kind of watches has existed in the market for many years and has gained wide acceptance. Some generic 3 hands analog watch has dual rotors. One motor is used to drive the second indicating hand and the other is used to drive minute and hour indicating hand. The rotor that drives minute indicating hand and hour indicating hands also drives the calendar disc. With dual rotor design, the calendar disc advances much faster than single rotor design.

The second kind of conventional watches usually comprises a single rotor which is arranged to drive a second indicating hand, a minute indicating hand, a hour indicating hand, and a calendar disc(s) (i.e. date disc, or date & day discs) to rotate, such that the second indicating hand, the minute indicating hand and the hour indicating hand are used to indicate current time, while the calendar disc(s) is used to indicate date information.

Finally, the third kind of convention watches usually comprises multiple rotors, in which a first motor is arranged to drive a second indicating hand, a minute indicating hand, a hour indicating hand, and other rotors are arranged to drive independent hands to indicate date, month, and/year independently.

There are several common disadvantages for these kinds of conventional watches. First, the calendar indication for these kinds of watches does not change from the thirtieth/twenty ninth to the first whenever necessary. As a result, users have to manually adjust the date of the watches to synchronize it with the current date. For example, when the real date changes from February 29th to March 1st, the calendar disc does not change from February 29th to March 1st. Instead, the date of the calendar disc will change from February 29th to February 30th!

Second, the conventional watches described above do not have internal time-keep function. In other words, the watches do not actually keep the actual time of the location in which it operates. Rather, the hands are merely driven to rotate at a predetermined time interval (typically one second) without referencing to any actual time. The consequence is that the user has to manually adjust the date and time of the watches whenever necessary.

Third, conventional watches do not illustrate time in different time zones. For example, a conventional watch described above may show only a time which is manually and initially set-up by its user (e.g. Pacific time). As a result, when the user wishes to obtain the time in another time zone (e.g. Eastern time or central time), he or she has to rely either on his or her general knowledge regarding the difference in time between the different time zones, or get the time from other sources other than his or her watch, such as from Internet.

Finally, many conventional watched have been modified to incorporate some sorts of perpetual calendars. However, such modified watches usually employ sophisticated electronic (such as a sophisticated central processing unit) as well as complicated and expensive mechanical components (such as a precisely manufactured gear unit) so that the overall manufacturing cost and the ultimate selling price of those watches are very high. Such expensive watches are not generally affordable for most people.

### SUMMARY OF THE PRESENT INVENTION

A main object of the present invention is to provide an analog timepiece such as an analog watch or an analog clock with a perpetual calendar which does not requires a user to manually adjust date, month and year information whenever a leap of day occurs.

Another object of the present invention is to provide an analog timepiece with a perpetual calendar which is adapted to maintain internal time-keeping so as to synchronize the internally kept time with the actual time of the location in which the watch operates.

Another object of the present invention is to provide an analog timepiece with a perpetual calendar which is capable of showing both time information and date information through a plurality of hands. In other words, the present invention can be incorporated into a wide variety of conventional watches without expensive implementation cost.

Another object of the present invention is to provide an analog timepiece with a perpetual calendar which merely utilizes convention control unit (i.e. a generic control unit) for accomplishing automatic date adjustment. In other words, the present invention does not involve complicated and expensive electronic and mechanical components. As such, the manufacturing cost of the present invention can be kept to the minimum.

Another object of the present invention is to provide an analog timepiece with a perpetual calendar which is arranged to selectively display time of different time zones so that a user is able to select to obtain time and date information regarding a predetermined location, and to switch the time and date shown from one time zone to another.

Another object of the present invention is to provide an analog timepiece, such as an analog watch or analog clock having an alarm function based on the internal time-keeping information. For conventional analog watches and clocks, there is no time-keeping feature inside the control unit so that alarm function is not able to synchronize with the actual time. This invention creates time-keeping inside the control unit so that alarm time can compare with the internal time-keeping so that alarm function can be realized in a generic low-cost analog watch or clock. The alarm can be a pre-set alarm time or a manually adjusted time.

Accordingly, in order to accomplish the above objects, the present invention provides an analog timepiece, comprising:

a casing having a receiving cavity and a display window for visually communicating the receiving cavity with an exterior of the casing;

a time indicating device provided on the casing for indicating time information including at least one of second information, hour information and minute information, and date information including at least one of day information, weekday information, month information and year information;

a quartz driving unit disposed in the receiving cavity for driving the time indicating hands to move at a predetermined interval in a controlled manner for indicating time; and

a perpetual calendar arrangement, which comprises:

a perpetual control unit which is arranged to create an internal time keeping such that the perpetual control unit is adapted to maintain an accurate current time and date, wherein the time indicating device is synchronized with the current time and date as maintained by the perpetual control unit so that the time indicating device is arranged to indicate a time which corresponds with the time internally kept by the perpetual control unit, wherein the perpetual control unit is arranged to display at least one of day information, month information, year information and weekday by the time indicating device, in such a manner that the corresponding day information, the weekday information, the month information and the year information are automatically adjusted according to the time internally maintained through the perpetual control unit, so that a user needs not manually adjust date, month and year indication on the timepiece.

From the above description, the present invention further provides a method of establishing a perpetual calendar for an analog watch or an analog clock (i.e. a timepiece) which comprises a casing, a time indicating device, showing time and date information, and a quartz driving unit, wherein the method is carried out through a perpetual calendar arrangement which comprises a perpetual control unit, and comprises the steps of:

(a) creating an internal time keeping by the perpetual control unit such that the perpetual control unit is adapted to maintain an accurate current time in a real-time basis;

(b) synchronizing the time indicating device with the current time as kept by the perpetual control unit such that the time indicating device is arrange to indicate a time which corresponds with the time internally kept by the perpetual control unit, and which is the actual current time; and

(c) setting up a calendar through the perpetual control unit and the time indicating device, in such a manner that day information, month information and year information are indicated by the time indicating device, in such a manner that the day information, the month information and the year information are automatically adjusted to correspond with a real date, month and year as kept internally by the perpetual control unit so that a user needs not manually adjust date, month and year indication on the watch.

### BRIEF DESCRIPTION OF THE DRAWINGS

FIG. 1 is a first schematic diagram of an analog timepiece having a perpetual calendar arrangement according to a preferred embodiment of the present invention.

FIG. 2 is a second schematic diagram of the analog timepiece having a perpetual calendar arrangement according to the preferred embodiment of the present invention, illustrating the interaction between internal components of the analog timepiece.

FIG. 3 is a method of implementing a perpetual calendar for an analog timepiece according to the preferred embodiment of the present invention.

FIG. 4 is a first alternative mode of the analog timepiece having a perpetual calendar arrangement according to the preferred embodiment of the present invention.

FIG. 5 is a second alternative mode of the analog timepiece having a perpetual calendar arrangement according to the preferred embodiment of the present invention.

FIG. 6 is a fourth alternative mode of the analog timepiece having a perpetual calendar arrangement according to the preferred embodiment of the present invention.

FIG. 7 is a fifth alternative mode of the analog timepiece having a perpetual calendar arrangement according to the preferred embodiment of the present invention.

### DETAILED DESCRIPTION OF THE PREFERRED EMBODIMENT

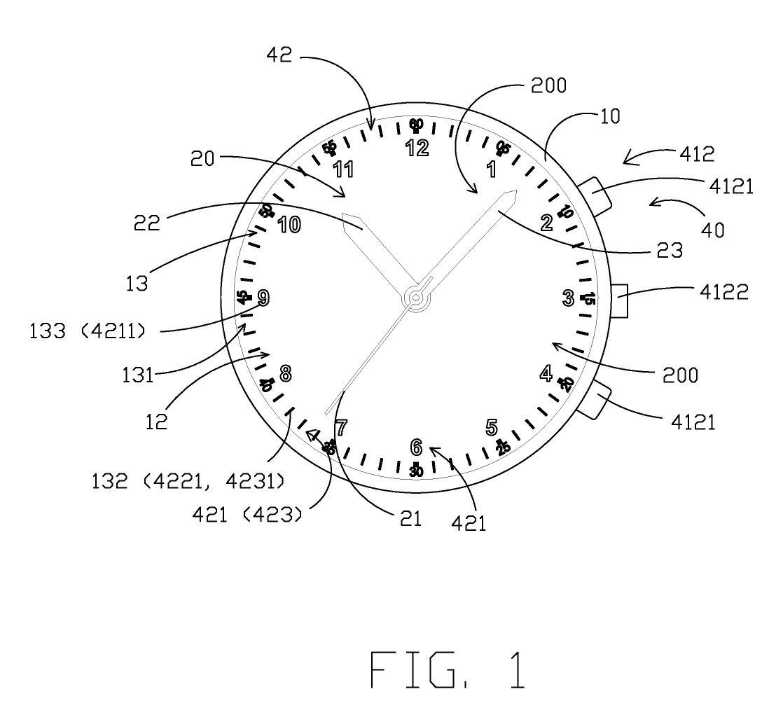

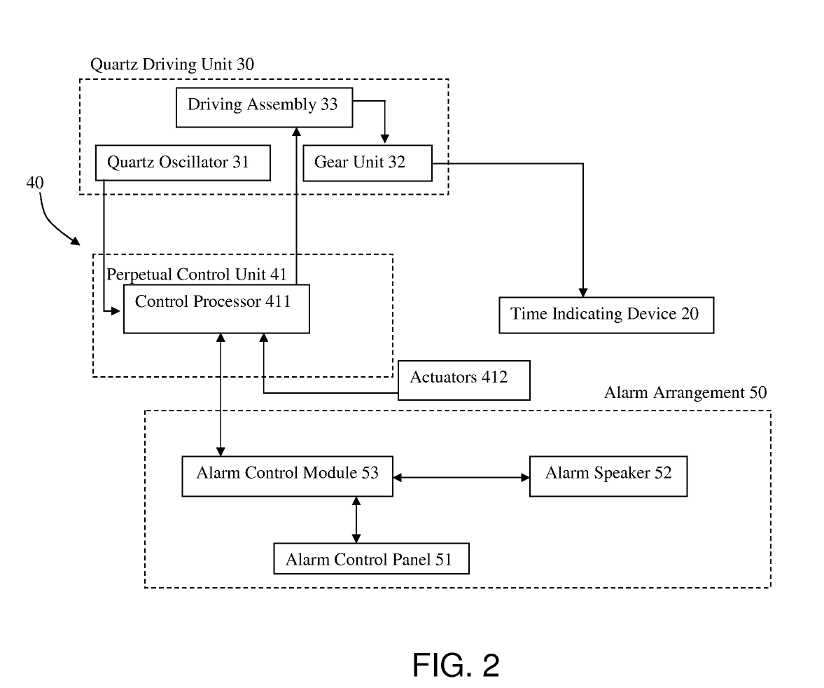

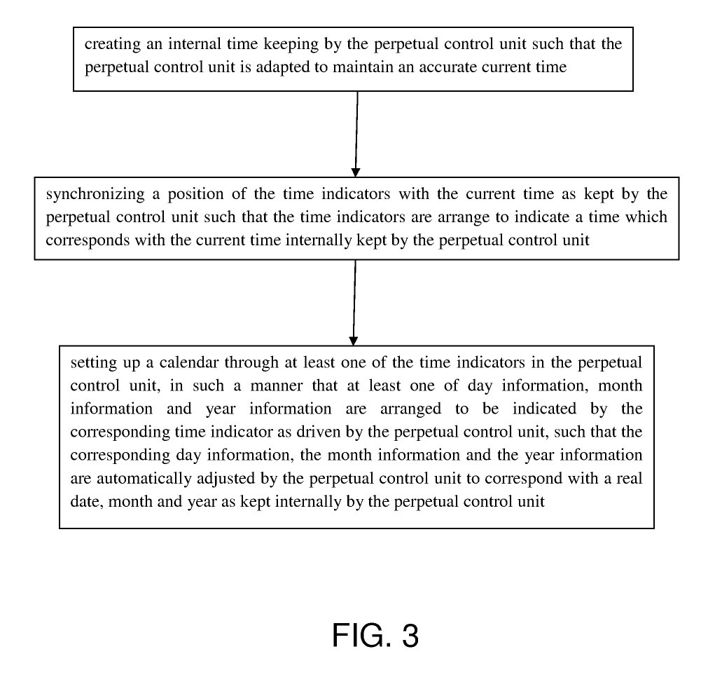

Referring to FIG. 1 to FIG. 3 of the drawings, an analog timepiece, such as an analog watch, or an analog clock with a perpetual calendar arrangement 40 according to a preferred embodiment of the present invention is illustrated, in which the analog timepiece comprises a casing 10, a time indicating device 20, an quartz driving unit 30, and a perpetual calendar arrangement 40. FIG. 1 to FIG. 2 illustrate that the analog timepiece is an analog watch. Note that, however, an analog clock can also be shown without departing from the spirit of the present invention.

The casing 10, which is adapted for being worn on a user's waist or mounting on an external fixture, such as on a wall, has a receiving cavity and a display window 12 for visually communicating the receiving cavity with an exterior of the casing 10, wherein the casing 10 further has a time chart 13 disposed within the receiving cavity to indicate time information.

The time indicating device 20 is provided on the casing 10 for indicating time and date (which is referred to as containing at least one of second information, minute information and hour information as time, and at least one of day information, month information and year information as date). The time indicating device 20 is the conventional time and/or date displaying device of a conventional timepiece, such as a plurality of time indicating hands (i.e. a second indicating hand 21, a minute indicating hand 23, and an hour indicating hand 22) and a calendar discs or hands. According to the preferred embodiment, the time indicating device 20 comprises a plurality of time indicators 200 (preferably first through third time indicators 200 in this particular embodiment) for indicating the time and date information of a particular moment. The first through third time indicators 200 comprises a second indicating hand 21, an hour indicating hand 22, and an minute indicating hand 23 respectively (collectively referred to as time indicating hands 21, 22, 23 hereinafter). The time indicating hands 21, 22, 23 are movably supported by the casing 10 within the receiving cavity.

The quartz driving unit 30 is disposed in the receiving cavity for driving the time indicating device 20 to move on the time chart 13 at a predetermined interval in a controlled manner for indicating time.

The perpetual calendar arrangement 40 comprises a perpetual control unit 41 arranged to create an internal time keeping such that the perpetual control unit 41 is adapted to maintain an accurate current time and date in a real-time basis, wherein the time indicating device 20 is synchronized with the current time and date as maintained by the perpetual control unit 41 so that the time indicating device 20 is arranged to indicate a time which corresponds with the time internally kept by the perpetual control unit 41, wherein the perpetual control unit 41 is arranged to display at least one of the day information, the month information and the year information through the date indicating device 20, in such a manner that the corresponding day information, the month information and the year information are automatically adjusted according to the time internally maintained by the perpetual control unit 41, so that a user needs not manually adjust date, month and year indication on the timepiece.

According to the preferred embodiment of the present invention, the casing 10 (in case of an analog watch) has a predetermined cross section and thickness for being fittedly worn on the user's waist (or in the case of an analog clock, mounted on a wall, or put on a desk), typically through a watch band flexibly extended from the casing 10. Moreover, the casing 10 can be made from different materials, such as metal or plastic, and can be designed and crafted to embellish the casing 10 with the most optimal aesthetic appearance. The time chart 13 is disposed within the receiving cavity and has a plurality of time markers 131 spacedly formed thereon to indicate the corresponding time information and/or date information. For example, the time markers 131 may be embodied as having sixty (60) second/minute markers 132 printed on the time chart 13 to indicate sixty seconds (and/or sixty minutes), twelve hour markers 133 for indicating twelve hours illustrated by the time chart 13. In this particular embodiment, these second/minute markers 132 and the hour markers 133 are used for time and calendar setup and for indicating the time as well as date information.

The quartz driving unit 30 comprises a quartz oscillator 31, a driving assembly 33 comprising a conventional stepping motor and/or a conventional rotor, and a gear unit 32. The quartz oscillator 31 is arranged to connect with the perpetual control unit 41. As a matter of conventional art, the quartz oscillator 31 produces stable and highly accurate oscillations per a predetermined interval of time so that the time indicating device 20 is driven to move on the time chart 13 for every predetermined interval of time.

The perpetual control unit 41 comprises a control processor 411 and a plurality of actuators 412 provided on the casing 10 and to drive the time indicating device 20 for accomplishing the internal time keeping and synchronization of the perpetual calendar arrangement 40. The actuators 412 may be embodied as having at least one actuating button 4121, at least one actuating stem 4122 movably and rotatably provided on the casing 10 to mechanically communicate with the control processor 411 and the time indicating device 20 to adjust the position of the time indicating hands 21, 22, 23. The control processor 411 is arranged to mechanically communicate with the quartz driving unit 30 and drive the time indicating device 20 to move to indicate on the time chart 13 for illustrating of current time, and operations regarding internal time adjustment and synchronization with the actual time in which the watch of the present invention operates. The quartz oscillator 31 initiates 32,760 pluses per second for the control perpetual control unit 41, which is arranged to drive the driving assembly 33 to drives the gear unit 32 for driving the time indicators 200 to move on the time chart 13.

From the above description, the present invention further provides a method of establishing a perpetual calendar for an analog timepiece which comprises a casing 10, a time indicating device 20 comprising at least one of first through third time indicators 200 for indicating corresponding second information, hour information and minute information respectively, wherein the method is carried out through a perpetual calendar arrangement 40 which comprises a perpetual control unit 41, and comprises the steps of:

(a) creating an internal time keeping by the perpetual control unit 41 such that the perpetual control unit 41 is adapted to maintain an accurate current time;

(b) synchronizing a position of the time indicators 200 (such as the second indicating hand 21 of the first time indicator 200) with the current time as kept by the perpetual control unit 41 such that the time indicators 200 are arrange to indicate a time which corresponds with the current time internally kept by the perpetual control unit 41;

(c) setting up a calendar through at least one of the time indicators 200 (such as the second indicating hand 21 of the first time indicator 200) in the perpetual control unit 41, in such a manner that at least one of day information, month information and year information are arranged to be indicated by the corresponding time indicator as driven by the perpetual control unit 41, such that the corresponding day information, the month information and the year information are automatically adjusted by the perpetual control unit 41 to correspond with a real date, month and year as kept internally by the perpetual control unit 41 so that a user needs not manually adjust date, month and year indication on the analog timepiece.

To elaborate the process of time internal time keeping and synchronization even further, the operation of the watch can be broken down into (1) internal time keeping and synchronization setup; and (2) calendar setup.

(1) Internal Time Keeping and Synchronization Setup

Internal time keeping setup can be further broken down into hour setup and minute setup by using the time indicating device 20. In this particular embodiment, the internal time keeping setup is accomplished by the time indicating hands 21, 22, 23 (i.e. the first through third time indicators 200). First, the user has to initially set up a current time for the watch of the present invention. The user may set up time in a rather conventional method. According to the preferred embodiment, the user needs to pull the actuating stem 4122 from the casing 10 to stop the movement of the indicating hands 20. The user then has to rotate the actuating stem 4122 to a predetermined position on the time chart 13 which corresponds to the current time. For example, when the current time is 6:00 pm, the user has to rotate the actuating stem 4122 to move the hour indicating hand 22 pointing at “6” of the hour marker 133 in the time chart 13, and to move the minute indicating hand 23 pointing at “60” of the minute marker 132 in the time chart 13. After the adjustment, the user has to push the actuating stem 4122 back to its original position on the casing 10.

Thus, step (a) comprises the steps of:

(a.1) initially setting up a current time for the watch, which includes at least one of (preferably both of) a current hour information and a current minute information;

(a.2) setting up hour information in the perpetual control unit 41 so as to allow the perpetual control unit 41 to store the hour information internally; and

(a.3) setting up minute information in the perpetual control unit 41 so as to allow the perpetual control unit 41 to store minute information internally.

For hour setup, after the user has pushed the actuating stem 4122 back to its original position, the control processor 411 of the perpetual calendar arrangement 41 is arranged to drive the second indicating hand 21 of the first time indictor 200 to a predetermined position (e.g. at “60” on the second marker 132 on the time chart 13). The user then needs to repetitively actuate one of the actuating buttons 4121. Each of the actuations moves the second indicating hand 21 of the first time indicator 200 to rotate one predetermined step on the time chart 13 (e.g. one second) so that five actuations would move the second indicating hand 21 of the first time indicator 200 to rotate five predetermined intervals (such as five seconds) on the time chart 13. The user needs to repetitively actuate the actuating button 4121 until the second indicating hand 21 of the first time indicator 200 aligns with the hour indicating hand 22.

As an example, when the current time is 3:30 pm, the user has to actuate the actuating buttons 4121 to bring the second indicating hand 21 of the first time indictor 200 to align to the hour indicating hand 22, which is somewhere between “3” and “4” on the time chart 13. Then, the user should drive the second indicating hand 21 of the first time indicator 200 to align to the hour indicating hand either at seventeenth steps or eighteenth steps from the “60” position on the time chart 13, which are the closest alignment position for the hour indicating hand 22 of the third time indicator 200. Since there are altogether 60 steps around the time chart 13. Thus, each step represents 12/60 hour or 0.20 hour or 12 Minutes on the time chart. 17 steps then equals to 17×0.20=3.40 hour that is equal to 3:24 and 18 steps equals to 18×0.20 Hour=3.6 Hour that is equal to 3:36 on the time chart 13. After the hour indicating hand 22 alignment, the user should press a predetermined actuating button 4121 to confirm the position of the second indicating hand 21 of the first time indicator 200. The control processor 411 is then arranged to remember this position for creating a Time of either 3:24 or 3:36 depending on where the user aligns the hour indicating hand 22 of the third time indicator 200 by the second indicating hand 21 of the first time indicator 200. It is worth mentioning that there could be a −6 minutes or +6 minutes time difference between the real time and the internal time maintained in the control processor 411 at 3:30. However, this +/−6 minutes accuracy is generally good enough for the movement to manage the calendar that advances every midnight at 12:00:00.

In other words, step (a.2) comprises the steps of:

(a.2.1) driving a first time indicator 200 (the second indicating hand 21) to a predetermined position by repetitively actuating at least one actuating button provided on the casing 10 until the first time indicator 200 (the second indicating hand 21) aligns with the second time indicator 200 (the hour indicating hand 22), wherein a position of the first time indicator 200 (the second indicating hand 21) represents hour information which is to be stored within the perpetual control unit 41, wherein when a position of the second time indicator 200 (the hour indicating hand 22) cannot align with the first time indicator 200 (the second indicating hand 21), the first time indicator 200 (the second indicating hand 21) is arranged to be driven to a position which is the nearest to the second time indicator 200 (the hour indicating hand 22); and

(a.2.2) inputting the hour information which corresponds to the position of the first time indicator 200 (the second indicating hand 21) to the perpetual control unit 41 by actuating a predetermined actuating button 4121 provided on the casing 10 as the hour information internally stored by the perpetual control unit 41.

For minute setup, the user has to repetitively actuate one of the predetermined actuating buttons 4121 to drive the second indicating hand 21 of the first time indicator 200 to align to the minute indicating hand 23 of the third time indicator 200. Using the same example of 3:30 pm, the second indicating hand 21 should forward 30 steps from 12 o'clock position. Since there are altogether 60 minutes around the clock in the time chart 13, therefore each step of the second indicating hand 21 is equal to 1 minute. Similarly, 30 steps equals to 30 minutes. As a result, the user has to actuate the predetermined actuating button 4121 thirty times to bring the second indicating hand 21 to align with the minute indicating hand 23. After the second indicating hands 21 aligns with the minute indicating hand 23, the user has to actuate one of the predetermined actuating buttons 4121 to confirm the minute setting in the perpetual control unit 41. The perpetual control unit 41 is then arranged to memorize the positions of the hour indicating hand 22 and the minute indicating hand 23 and update internal timekeeping data inside the movement from 3:24 or 3:40 to 3:30. In other words, the newly entered position of the minute indicating hand 23 supersedes the minute information derived from the hour indicating hand 22, yet hour information (i.e. 3'o clock) has nevertheless been established.

In other words, step (a.3) comprises the steps of:

(a.3.1) driving the first time indicator 200 (the second indicating hand 21) to move to a predetermined position by repetitively actuating a predetermined actuating buttons provided on the casing 10 until the first time indicator 200 (the second indicating hand 21) aligns with the third time indicator 200 (i.e. the minute indicating hand 23), wherein a position of the first time indicator 200 (the second indicating hand 21) represents hour information which is to be stored within the perpetual control unit 41; and

(a.3.2) inputting the minute information which corresponds to the position of the first time indicator 200 to the perpetual control unit 41 by actuating a predetermined actuating button 4121 provided on the casing 10 as the minute information internally stored by the perpetual control unit.

It is worth mentioning that it is possible that the process for the internal time setting can be designed and programmed in such a manner that the user needs only to align the second indicating hand 21 with the hour indicating hand 22 without aligning the minute indicating hand 23. In such situation, the error between the internally set time and the real time would be greater, but the setup time is shorter and easier. Moreover, when the actual time is not 3:30 pm but 3:00 pm, then user only need to align the hour indicating hand 22 once without aligning the minute indicating hand 23 to get an accurate time alignment between the internally kept time by the control processor 411 and the actual time. In other words, the present invention can be designed and manufactured to accommodate a wide range of situations so as to provide the more convenient and the simplest watch for users having different needs.

(2) Calendar Setup

The perpetual calendar arrangement 40 further comprises a date illustrator 42 provided on the casing 10 for displaying date information to a user of the watch of the present invention.

In order to show day information on the time chart 13, the date illustrator 42 comprises a month indicator 421, a day indicator 422, and a year indicator 423 provided on the time chart 13 for illustrating month information and day information respectively. The day indicator 422 contains a plurality (preferably 31) day markers 4221 spacedly and evenly formed on the time chart 13 so that thirty one predetermined positions can be assigned corresponding to the movement of the second indicating hand 21 to indicate date information. An example of such an indication includes, but not limited to, 12:00:01 as first day, 12:00:02 as second day, so on and so forth, until 12:00:31 as thirty first day.

When the calendar setup is performed by one of the first through third time indicators 200, the month indicator 421, the day indicator 422, and the year indicator 423 coincide with the second/minute markers 132 and/or the hour marker 133, wherein some of the second/minute marker 132 and the hour marker 133 are designated as indication of predetermined day, month or year.

Thus, step (c) comprises the steps of:

(c.1) setting up an initial the day information in the perceptual control unit 41 by actuating at least one of the actuating buttons 4121 in a predetermined manner;

(c.2) setting up an initial the month information in the perceptual control unit by 41 actuating at least one of the actuating buttons 4121 in a predetermined manner; and

(c.3) setting up an initial the year information in the perceptual control unit 41 by actuating at least one of the actuating buttons 4121 in a predetermined manner.

The user of the present invention may initially set up the starting day of the perpetual calendar arrangement 40 as follows: to allow day adjustment or initial setup, the user may need to actuate one of the predetermined actuating buttons 4121 in a predetermined manner, such as pressing that predetermined actuating buttons 4121 twice. Then the user is then able to adjust the position of one of the time indicators 200 (such as the second indicating hand 21 of the first time indicator 200) by pressing a predetermined actuating button 4121 so as to input an initial or the current day to the perpetual control unit 41. For example, the user may press the corresponding actuating buttons 4121 three times to bring the second indicating hand 21 to stop at a particular day marker 4221 (e.g. “3” second marker 132) on the time chart 13 when the current day is the third of a month. When the second indicating hand 21 is properly set (i.e. when the day information is properly set), the user needs to actuate another predetermined actuating buttons 4121 to end the adjustment process. When the day adjustment process has completed, the second indicating hand 21 will return to its original position. It is worth mentioning that in this particular embodiment, the day markers 4221 coincide with the second/minute markers 132, wherein the second/minute markers 132 for 0/60 second to thirty first second are specifically designated or represented as day 1 to day 31 respectively.

Thus, step (c.1) comprises the steps of:

(c.1.1) actuating at least one of the predetermined actuating buttons 4121 in a predetermined manner to trigger day adjustment in the perpetual control unit 41; and

(c.1.2) driving one of the time indicator 200 (e.g. the second indicating hand 21 of the first time indicator 200) to move to a predetermined position which corresponds to a current day by repetitively actuating a predetermined actuating button 4121, wherein the current day is represented by a day marker 4221 provided on a time chart 13 disposed within the casing 10; and

(c.1.3) actuating one of the predetermined actuating buttons 4121 to end the day adjustment.

In order to show month information on the time chart 13, the month indicator 421 contains a plurality (preferably twelve) month markers 4211 spacedly and evenly formed on the time chart 13 so that twelve predetermined positions can be assigned on the movement of the second indicating hand 21 or any predetermined time indicator 200 on the time chart 13 to indicate month information. For example, the January month marker 4211 may be formed on the time chart 13 aligning with 1 o'clock, and the February month marker 4211 may be formed on the time chart 13 to align with 2 o'clock.

To enter month information of a week, the user needs to actuate a predetermined actuating buttons 4121 by pressing it in a predetermined manner (e.g. by pressing the corresponding actuating button 4121 four times). Then the user is able to adjust the position of the one of the predetermined time indicators 200 (such as the second indicating hand 21 of the first time indicator 200) by pressing a predetermined actuating button 4121 so as to input an initial or the current month to the perpetual control unit 41. For example, the user may press the corresponding actuating buttons 4121 two times to bring the second indicating hand 21 to stop at the “February” month marker 4211 (which is specifically designated or represented as “2” of the hour marker 133) on the time chart 13 when the current month is February. When the second indicating hand 21 is properly set (i.e. when the month information is properly set), the user needs to actuate another predetermined actuating buttons 4121 to end the month adjustment process. When the month adjustment process has completed, the second indicating hand 21 will return to its original position.

Hence, step (c.2) further comprises the steps of:

(c.2.1) actuating at least one of the predetermined actuating buttons 4121 in a predetermined manner to trigger month adjustment in the perpetual control unit 41; and

(c.2.2) driving one of the time indicators 200 (such as the second indicating hand 21 of the first time indicator 200) to move to a predetermined position which corresponds to a current month by repetitively actuating a predetermined actuating button 4121, wherein the current month is represented by a month marker 4211 provided on a time chart 13 disposed within the casing 10; and

(c.2.3) actuating one of the predetermined actuating buttons 4121 to end the month adjustment.

In order to show year information on the time chart 13, the year indicator 423 contains a plurality (preferably sixty) year markers 4231 spacedly and evenly formed on the time chart 13 so that sixty predetermined positions can be assigned on the movement of on of the time indicators 200 (such as the second indicating hand 21 of the first time indicator 200) on the time chart 13 to indicate year information. For example, the 2008 year marker 4231 may be formed on the time chart 13 aligning with “60” second marker 132, and the 2009 year marker 4231 may be formed on the time chart 13 to aligning with “1” second marker 132.

To enter the year information, the user needs to actuate a predetermined actuating buttons 4121 by pressing it in a predetermined manner (e.g. by pressing the corresponding actuating button 4121 five times). Then the user is able to adjust the position of one of the time indicators 200 (such as the second indicating hand 21 of the first time indicator 200) by pressing a predetermined actuating button 4121 so as to input an initial or the current year to the perpetual control unit 41. For example, the user may press the corresponding actuating buttons 4121 one time to bring the second indicating hand 21 to stop at the “2009” year marker 4231 on the time chart 13 when the current month is 2009. When the second indicating hand 21 is properly set (i.e. when the year information is properly set), the user needs to actuate another predetermined actuating buttons 4121 to end the year adjustment process. When the year adjustment process has completed, the second indicating hand 21 will return to its original position. Note that the input of year allows the movement of the second indicating hand 21 to account for leap year so that day of February can be adjusted accordingly, wherein the adjustment of day and year is accomplished by perpetual control unit 41. Accordingly, user of the present invention is able to initially set up the calendar manually following the above procedures. The perpetual control unit 41 records all the input data and can advance and adjust the calendar (i.e. day information, weekday information, month information and year information) according to an actual calendar.

Step (c.3) further comprises the steps of:

(c.3.1) actuating at least one of the predetermined actuating buttons 4121 in a predetermined manner to trigger year adjustment in the perpetual control unit 41; and

(c.3.2) driving a predetermined time indicator (such as the second indicating hand 21 of the first time indicator 200) to move to a predetermined position which corresponds to a current year by repetitively actuating a predetermined actuating button 4121, wherein the current year is represented by a year marker 4231 provided on a time chart 13 disposed within the casing 10; and

(c.3.3) actuating one of the predetermined actuating buttons 4121 to end the year adjustment.

In order to display the calendar by the watch of the present invention, the user may need to actuate a predetermined actuating button 4121 in a predetermined sequence to show the day information, the month information and the year information in an ordered manner. There are many variations in which the calendar can be displayed. For example, the day information, the weekday information, the month information and the year information can be displayed by repetitively pressing a predetermined actuating button 4121 to sequentially show the day information, the month information and the year information respectively. For example, the user may press a predetermined actuating button once to show the day information, twice to show the month information and three times to show the year information. Alternatively, the perpetual control unit 41 can be pre-programmed to respond to a single actuation of a predetermined actuating button 4121 by discretely and sequentially drive a predetermined time indicator 200 (such as the second indicating hand 21 of the first time indicator 200) to show the day information, the month information and the year information, each for a predetermined period of time.

Accordingly, it is also important to mention that the initial time and calendar setting can also be performed through a single actuating button 4121, following a procedure substantially similar to what is described above, except that the procedures set forth above are performed through actuating a single actuating button 4121.

(1) Internal Time Keeping Setup for a Single Actuating Button 4121

Internal time keeping setup can be further broken down into hour setup and minute setup. First, the user has to initially set up a current time for the watch of the present invention. The user may set up time in a rather conventional method. According to the preferred embodiment, the user needs to pull the actuating stem 4122 from the casing 10 to stop the operation of the time indicators 200. The user then has to rotate the actuating stem 4122 to a predetermined position on the time chart 13 which corresponds to the current time. For example, when the current time is 6:00 pm, the user has to rotate the actuating stem 4122 to move one of the time indicators 200 (such as the hour indicating hand 22 of the second time indicator 200) pointing at “6” of the hour marker 133 in the time chart 13, and to move the minute indicating hand 23 pointing at “60” of the minute marker 132 in the time chart 13. After the adjustment, the user has to push the actuating stem 4122 back to its original position on the casing 10.

For hour setup, after the user has pushed the actuating stem 4122 back to its original position, the control processor 411 of the perpetual calendar arrangement 41 is arranged to drive a predetermined time indicator 200 (such as the second indicating hand 21 of the first time indicator 200) to a predetermined position (e.g. at “60” on the second marker 132 on the time chart 13). The user then needs to repetitively actuate a single actuating button 4121. Each of the actuations moves the second indicating hand 21 to rotate one predetermined step on the time chart 13 (e.g. on second) so that five actuations would move the second indicating hand 21 to rotate five seconds on the time chart 13. The user needs to repetitively actuate the actuating button 4121 until the second indicating hand 21 aligns with the hour indicating hand 22.

As an example, when the current time is 3:30 pm, the user has to actuate a single predetermined actuating button 4121 to bring the second indicating hand 21 to align to one of the predetermined time indicators 200 (such as the hour indicating hand 22 of the second time indicator 200), which is somewhere between “3” and “4” on the time chart 13. Then, the user should drive the second indicating hand 21 to align to the hour indicating hand either at seventeenth steps or eighteenth steps from the ‘60’ position on the time chart 13, which are the closest alignment position for the hour indicating hand 22. Since there are altogether 60 steps around the time chart 13. Thus, each step represents 12/60 hour or 0.20 hour or 12 Minutes on the time chart. 17 steps then equals to 17×0.20=3.40 Hour that is equal to 3:24 and 18 steps equals to 18×0.20 Hour=3.6 Hour that is equals to 3:36 on the time chart 13. After the hour indicating hand 22 alignment, the user should press the predetermined single actuating button 4121 to confirm the position of the second indicating hand 21. The control processor 411 is then arranged to remember this position for creating a Time of either 3:24 or 3:36 depending on where the user aligns the hour indicating hand 22 by the second indicating hand 21. It is worth mentioning that there could be a −6 minutes or +6 minutes time difference between the real time and the internal time maintained in the control processor 411 at 3:30. However, this +/−6 minutes accuracy is generally good enough for the movement to manage the calendar that advances every midnight at 12:00:00.

For minute setup, the user has to repetitively actuate the single predetermined actuating button 4121 to drive a predetermined time indicator 200 (such as the second indicating hand 21 of the first time indicator 200) to align with another predetermined time indicator 200 (such as the minute indicating hand 23 of the third time indicator 200). Using the same example of 3:30 pm, the second indicating hand 21 should forward 30 steps from 12 o'clock position. Since there are altogether 60 minutes around the clock in the time chart 13, therefore each step of the second indicating hand 21 is equal to 1 minute. 30 steps equals to 30 minutes. As a result, the user has to actuate the predetermined actuating button 4121 thirty times to bring the second indicating hand 21 to align with the minute indicating hand 23. After the second indicating hands 21 aligns with the minute indicating hand 23, the user has the single predetermined actuating button 4121 to confirm the minute setting in the perpetual control unit 41. The perpetual control unit 41 is then arranged to memorize the positions of the hour indicating hand 22 and the minute indicating hand 23 and update internal timekeeping data inside the movement from 3:24 or 3:40 to 3:30. In other words, the newly entered minute indicating hand 23 position supersedes the minute information derived from the hour indicating hand 22, yet hour information (i.e. 3'o clock has nevertheless been established).

It is worth mentioning that it is possible that the process for the internal time setting can be designed and programmed in such a manner that the user needs only to align the second indicating hand 21 with the hour indicating hand 22 without aligning the minute indicating hand 23. In such situation, the error between the internally set time and the real time would be greater, but the setup time is shorter and easier. Moreover, when the actual time is not 3:30 pm but 3:00 pm, then user only need to align the hour indicating hand 22 once without aligning the minute indicating hand 23 to get an accurate time alignment between the internally kept time by the control processor 411 and the actual time. In other words, the present invention can be designed and manufactured to accommodate a wide range of situations so as to provide the more convenient and the simplest watch for users having different needs.

(2) AM/PM Setting

For am/pm setting, two predetermined positions on the time chart 13 can be assigned (e.g. 9 o'clock as AM and 3 o'clock as PM) as representing am/pm setting. When the current time and the internal time have been set, the perpetual control unit 41 is arranged to drive the second indicating hand 21 to one of the predetermined positions. The user may then actuate one of the predetermined actuating buttons 4121 to confirm the current morning (am) or afternoon (pm) setting, or to actuate another actuating buttons 4121 to switch from one of the predetermined position to another for adjusting the correct am/pm setting. After the correct setting, the user has to actuate one of the predetermined actuating buttons 4121 to end the am/pm setting procedure. As such, the perpetual control unit 41 will have the right time and AM/PM information to advance calendar once every 12:00:00 am at midnight.

Thus, step (c) further comprises a step (c.4) of setting up an initial morning and afternoon information by actuating at least one of the actuating buttons 4121 in a predetermined manner, wherein step (c.4) comprises the steps of:

(c.4.1) assigning two predetermined positions on a time chart 13 to represent, respectively, morning and afternoon for a given date;

(c.4.2) actuating at least one of the predetermined actuating buttons 4121 in a predetermined manner to trigger morning and afternoon setting adjustment in the perpetual control unit 41; and

(c.4.3) driving a predetermined time indicator 200 (such as the second indicating hand 21 of the first time indicator 200) to move to one of the predetermined positions on the time chart 13 which corresponds to one of the morning and the afternoon information by repetitively actuating a predetermined actuating button 4121; and

(c.4.4) actuating at least one predetermined actuating button 4121 to end the morning and afternoon setting adjustment.

(3) Calendar Setup

According to the preferred embodiment of the present invention, one of the time indicators 200 is utilized to illustrate calendar (such as the second indicating hand 21 of the first time indicator 200). The perpetual calendar arrangement 40 further comprises a date illustrator 42 provided on the casing 10 for displaying date information to a user of the watch of the present invention.

In order to show day information on the time chart 13, the date illustrator 42 comprises a month indicator 421, a day indicator 422, and a year indicator 423 provided on the time chart 13 for illustrating month information and day information respectively. The day indicator 422 contains a plurality (preferably 31) day markers 4221 spacedly and evenly formed on the time chart 13 so that thirty one predetermined positions can be assigned corresponding to the movement of the second indicating hand 21 to indicate date information. An example of such an indication includes, but not limited to, 12:00:01 as first day, 12:00:02 as second day, so on and so forth, until 12:00:31 as thirty first day.

When the calendar setup is performed by one of the first through third time indicators 200, the month indicator 421, the day indicator 422, and the year indicator 423 coincide with the second/minute markers 132 and/or the hour marker 133, wherein some of the second/minute marker 132 and the hour marker 133 are designated as indication of predetermined day, month or year

The user of the present invention may initially set up the starting day of the perpetual calendar arrangement 40 as follows: to allow day adjustment or initial setup, the user may need to actuate the single predetermined actuating button 4121 in a predetermined manner, such as pressing that predetermined actuating button 4121 twice. Then the user is able to adjust the position of the second indicating hand 21 (or any other time indicator 200) by pressing the single predetermined actuating button 4121 so as to input an initial or the current day to the perpetual control unit 41. For example, the user may press the corresponding actuating button 4121 three times to bring the second indicating hand 21 (or any other predetermined time indicator 200) to stop at the “3” day marker 4221 (i.e. the second/minute marker 132 for this particular embodiment of the present invention) on the time chart 13 when the current day is the third of a month. When the second indicating hand 21 (or any other predetermined time indicator 200) is properly set (i.e. when the day information is properly set), the user needs to actuate the single predetermined actuating button 4121 to end the adjustment process. When the day adjustment process has completed, the second indicating hand 21 will return to its original position.

To enter the month information of a week, the user needs to actuate the same single actuating button 4121 by pressing it in a predetermined manner (e.g. by pressing the corresponding actuating button 4121 four times). Then the user is able to adjust the position of the corresponding time indicator 200 (such as the second indicating hand 21 of the first time indicator 200) by pressing a predetermined actuating button 4121 so as to input an initial or the current month to the perpetual control unit 41. For example, the user may press the corresponding actuating button 4121 two times to bring the second indicating hand 21 to stop at the “February” month marker 4211 (which corresponds to a designated hour marker 133, as described above) on the time chart 13 when the current month is February. When the second indicating hand 21 is properly set (i.e. when the month information is properly set), the user needs to actuate that single predetermined actuating button 4121 once more to end the month adjustment process. When the month adjustment process has completed, the second indicating hand 21 will return to its original position.

In order to show year information on the time chart 13, the year indicator 423 contains a plurality (preferably sixty) year markers 4231 spacedly and evenly formed on the time chart 13 so that sixty predetermined positions can be assigned on the movement of a predetermined time indicator 200 (such as the second indicating hand 21 of the first time indicator 200) on the time chart 13 to indicate year information. These year markers 4231, as mentioned earlier, coincide with specifically designated second/minute markers 132. For example, the 2008 year marker 4231 may be formed on the time chart 13 aligning with “60” second marker 132, and the 2009 year marker 4231 may be formed on the time chart 13 to aligning with “1” second marker 132.

To enter the year information, the user needs to actuate the single predetermined actuating button 4121 by pressing it in a predetermined manner (e.g. by pressing the corresponding actuating button 4121 five times). Then the user is able to adjust the position of the corresponding time indicator 200 (such as the second indicating hand 21 of the first time indicator 200) by pressing a predetermined actuating button 4121 so as to input an initial or the current year to the perpetual control unit 41. For example, the user may press the corresponding actuating button 4121 one time to bring the second indicating hand 21 to stop at the “2009” year marker 4231 on the time chart 13 when the current month is 2009. When the second indicating hand 21 is properly set (i.e. when the year information is properly set), the user needs to actuate the single predetermined actuating button 4121 to end the year adjustment process. When the year adjustment process has completed, the relevant time indicator 200 (such as the second indicating hand 21 of the first time indicator 200) will return to its original position. Note that the input of year allows the movement of the second indicating hand 21 to account for leap year so that day of February can be adjusted accordingly, wherein the adjustment of day and year is accomplished by perpetual control unit 41. Accordingly, user of the present invention is able to initially set up the calendar manually following the above procedures. The perpetual control unit 41 records all the input data and can advance and adjust the calendar (i.e. day information, month information and year information) according to an actual calendar.

In order to display the calendar by the watch of the present invention when the date information is represented by the first through third time indicators 200, the user may need to actuate the corresponding predetermined actuating button 4121 in a predetermined sequence to show the day information, the month information and the year information in an ordered manner. There are many variations in which the calendar can be displayed. For example, the day information, the month information and the year information can be displayed by repetitively pressing the predetermined actuating button 4121 to sequentially show the day information, the weekday information, the month information and the year information respectively. For example, the user may press a predetermined actuating button once to show the day information, twice to show the month information and three times to show the year information. Alternatively, the perpetual control unit 41 can be pre-programmed to respond to a single actuation of a predetermined actuating button 4121 by discretely and sequentially drive the second indicating hand 21 to show the day information, the month information and the year information, each for a predetermined period of time. It is important to mention, however, that the time and date information in this particular embodiment of the present invention is illustrated by the first through third time indicators 200. However, the same information can also be indicated by addition time indicators 200 (fourth through seventh time indicators 200) as mentioned below. In such a situation, the first through third time indicators 300 indicate only the time information (i.e. second information, hour information and minute information), while the fourth through seventh time indicators 200 indicator date information (i.e. day information, month information and year information, and weekday information).

The perpetual calendar arrangement 40 is meant to allow automatic adjustment of date for leap year or for different days of a month. Thus, when time and calendar are set up according to the above procedures, the perpetual control unit 41 is arranged to control the date display in the following manner:

(i) For month with 31 days, the movement just let the corresponding time indicator 200 (such as the second indicating hand 21 of the first time indicator 200) to show “31” as the last day of a particular month, such as in May;

(ii) For month with 30 days, the perpetual control unit 41 is arranged to drive the corresponding time indicator 200 (such as the second indicating hand 21 of the first time indicator 200) to advance for 24 hours through the quartz driving unit 30 so as to adjust the day information to skip the 31 at the end of the day of 30. This can also be done by automatically adjusting the position of the corresponding time indicator 200, such as the day disc 24 of the fourth time indicator 200 and weekday, as described below.

(iii) For month with 28 days, the perpetual control unit 41 is arranged to drive the corresponding time indicator 200 (such as the second indicating hand 21 of the first time indicator 200) through the quartz driving unit 30 to advance for 3×24 (i.e. 72) hours to adjust the day information to skip the 29, 30 and 31 at the end of the day of 28; and

(iv) For month with 29 days, the perpetual control unit 41 is arranged to drive the corresponding time indicator 200 (such as the second indicating hand 21 of the first time indicator 200) through the quartz driving unit 30 to advance for 2×24 (i.e. 48) hours to adjust the day information to skip the 30 and 31 at the end of the day of 28.

In other words, step (c) further comprises a step (c.5) of pre-programming the perpetual control unit 41 to automatically adjust at least one of the day information, the month information and the year information in the following manner:

(i) for month with thirty one days, driving the corresponding time indicator 200 (such as the second indicating hand 21 of the first time indicator 200) to show day “31” as a last day of a particular month;

(ii) for month with thirty days, driving the corresponding time indicator 200 (such as the second indicating hand 21 of the first time indicator 200) to advance for twenty four hours so as to adjust the day information to skip the day “31” at the end of day “30” for the particular month;

(iii) for month with 28 days, driving the corresponding time indicator 200 (such as the second indicating hand 21 of the first time indicator 200) to advance for seventy two hours to adjust the day information to skip day “29”, day “30” and the day “31” at the end of day “28” for the particular month; and

(iv) for month with 29 days, driving the corresponding time indicator 200 (such as the second indicating hand 21 of the first time indicator 200) to advance for forty eight hours to adjust the day information to skip the day “30” and the day “31” at the end of the day “28” for the particular month.

The analog timepiece can also show weekday information. The day indicator 422 further contains a plurality of weekday markers 4222 which coincide with the second/minute markers 132 or the hour marker 133. The weekday markers 4222 therefore represent seven mark positions: namely Monday, Tuesday, Wednesday, Thursday, Friday, Saturday and Sunday. These seven mark positions are predetermined positions assigned on the time chart 13 to indicate weekday information, and the weekday markers 4222 coincide with the second/minute marker 132 or the hour marker 133. For example, Monday marker 4222 can be formed at a position aligning 12:00:05 (a designated second/minute marker 132), while Tuesday marker 4222 can be formed at a position aligning 12:00:10, so on and so forth (i.e. 12:00:15 as Wednesday, 12:00:20 as Thursday, 12:00:25 as Friday, 12:00:30 as Saturday, 12:00:35 as Sunday). Accordingly, the seven predetermined positions can be assigned on the movement of the second indicating hand 21 to indicate weekday information, so that the corresponding time indicator 200 (such as the second indicating hand 21 of the first time indicator 200) is arranged to be driven to move to the corresponding positions on the time chart 13 to point to the corresponding weekday marker 4222 for illustrating the corresponding weekday.

To enter the weekday information of a week, the user needs to actuate a predetermined actuating buttons 4121 by pressing it in a predetermined manner (e.g. by pressing the corresponding actuating button 4121 three times). Then the user is able to adjust the position of one of the time indicator (e.g. the second indicating hand 21 of the first time indicator 200) by pressing a predetermined actuating button 4121 so as to input an initial or the current weekday to the perpetual control unit 41. For example, the user may press the corresponding actuating buttons 4121 three times to bring the second indicating hand 21, as an example, to stop at the “Wednesday” weekday marker 4222 on the time chart 13 when the current day is Wednesday. When the second indicating hand 21 is properly set (i.e. when the weekday information is properly set), the user needs to actuate another predetermined actuating buttons 4121 to end the adjustment process. When the weekday adjustment process has completed, the second indicating hand 21 will return to its original position.

Thus, step (c.1) further comprises the steps of:

(c.1.4) actuating at least one of the predetermined actuating buttons 4121 in a predetermined manner to trigger weekday adjustment in the perpetual control unit 41; and

(c.1.5) driving one of the time indicators 200, such as the first the second indicating hand 21 of the first time indicator 200 to move to a predetermined position which corresponds to a current weekday by repetitively actuating a predetermined actuating button 4121, wherein the current weekday is represented by a weekday marker 4222 provided on a time chart 13 disposed within the casing 10; and

(c.1.6) actuating one of the predetermined actuating buttons 4121 to end the weekday adjustment.

By using just only one actuating button 4121, to enter the weekday information of a week, the user needs to actuate the single predetermined actuating button 4121 by pressing it in a predetermined manner (e.g. by pressing the corresponding actuating button 4121 three times). Then the user is able to adjust the position of the predetermined time indicator (such as the second indicating hand 21 of the first time indicator 200) by pressing a predetermined actuating button 4121 so as to input an initial or the current weekday to the perpetual control unit 41. For example, the user may press the corresponding actuating button 4121 three times to bring the second indicating hand 21 to stop at the “Wednesday” weekday marker 4222 on the time chart 13 when the current day is Wednesday. When the second indicating hand 21 is properly set (i.e. when the weekday information is properly set), the user needs to actuate that single predetermined actuating button 4121 once more to end the adjustment process. When the weekday adjustment process has completed, the corresponding time indicator 200 will return to its original position.

It is important to mention that the watch of the present invention may also be utilized to display time of different time zones. Thus, the control processor 411 of the perpetual control unit 41 is also pre-programmed to switch time and calendar display for different time zones upon initial setup of an initial time and date information. For switching and displaying of different time zone, the user may carry out the following procedures as a preferred embodiment of the present invention:

(1) the user has to actuate (by pressing) one of the actuating buttons 4121 once to show “Time 2”, which is the time in a second time zone other than the one in the location in which the watch operates (for example, the preset value is the actual of the current time zone). If the real-time clock is 3:21 pm, pressing the corresponding actuating button 4121 will signal the perpetual control unit 41 to drive a predetermined time indicator 200 (such as the second indicating hand 21 (or other predetermined hands 22, 23) of the first time indicator 200) to spin to pause at 12 o'clock for 2 seconds and then stop at 3 o'clock for 5 second;

(2) After displaying “Time 2” Hour for 5 seconds, the corresponding second indicating hand 21 (or other predetermined time indicator 200) spins to show AM/PM for 5 seconds and then return to normal mode (i.e. showing the current time in the time zone in which the watch operates). The procedure for showing morning/afternoon is exactly the same as those described above.

In other words, the method further comprises a step (d) of displaying the time information and date information for at least two different time zones, wherein step (d) comprises the steps of:

(d.1) driving the one of the time indicator 200 (such as the second indicating hand 21 of the first time indicator 200) to spin to pause at a predetermined position for a predetermined period of time, and to advance to another predetermined position which indicate the hour information of the different time zone; and

(d.2) driving the corresponding time indicator 200 (such as the second indicating hand 21 of the first time indicator 200) to spin to a predetermined position which is one of the predetermined positions to correspond to the morning and the afternoon indication on the time chart 13.

In order to set the time for, say “Time 2” (i.e. a second time zone), the user has to follow these procedures:

(3) actuating a predetermined actuating button 4121 once to show the time in the second time zone. For example, if the real-time clock is 3:21 pm, pressing S2 once to spin a predetermined time indicator 200 (such as the second indicating hand 21 of the first time indicator 200) to pause at a predetermined position for a predetermined time interval;

(4) While the hour of “Time 2” time zone is displaying, actuating a predetermined actuating button 4121 in a predetermined manner (by pressing and holding it) more than a predetermined period of time (e.g. 0.6 second) to allow the perpetual control unit 41 to drive the predetermined time indicator 200 (such as the second indicating hand 21 of the first time indicator 200) to spin advance by 1 hour;

(5) setting the correct time for the second time zone (i.e. “Time2”) by actuating a predetermined actuating button 4121;

(6) If there is no additional input or adjustment (i.e. actuation of the predetermined actuating button 4121) for more than a predetermined period of time, the “Time2” Hour is confirmed by the perpetual control unit 41, which then drives the predetermined time indicator 200 (such as the second indicating hand 21 of the first time indicator 200) to show morning/afternoon setting;

(7) while AM/PM setting is being displayed by the predetermined time indicator 200 (such as the second indicating hand 21 of the first time indicator 200) through pointing at a predetermined position on the time chart 13, actuating a predetermined actuating button 4121 for more than a predetermined period of time (e.g. 0.6 second) will allow the perpetual control unit 41 to spin the predetermined time indicator 200 (such as the second indicating hand 21 of the first time indicator 200) to change am/pm setting by pointing at a different predetermined position on the time chart 13 representing the correct am/pm indication;

(8) If there is no additional input or adjustment (i.e. actuation of the predetermined actuating button 4121) for more than a predetermined period of time, the “Time2” am/pm setting is confirmed by the perpetual control unit 41.

Thus, step (d) further comprises a step (d.3) of setting a time of the second time zone, wherein the step (d.3) comprises the steps of:

(d.3.1) while the time information of the first time zone is displayed, actuating a predetermined actuating button 4121 once to show the time information of the second time zone;

(d.3.2) while the time information of the second time zone is displayed, actuating a predetermined actuating button 4121 in a predetermined manner to allow the perpetual control unit 41 to drive the predetermined time indicator 200 (such as the second indicating hand 21 of the first time indicator 200) to spin to advance by one hour;

(d.3.3) setting the time information for the second time zone by actuating a predetermined actuating button 4121;

(d.3.4) confirming the time information for the second time zone, wherein the predetermined time indicator 200 (such as the second indicating hand 21 of the first time indicator 200) is then driven to show morning and afternoon setting;

(d.3.5) actuating a predetermined actuating button in a predetermined manner to adjust morning and afternoon setting by driving the predetermined time indicator 200 (such as the second indicating hand 21 of the first time indicator 200) to point at a different predetermined position which is pre-assigned to indicate the morning or the afternoon setting; and

(d.3.6) confirming the morning and the afternoon setting for the second time zone.

The analog timepiece further comprises an alarm arrangement 50 provided in the timepiece for providing alarm function in conjunction with the perpetual calendar arrangement 40. Note that the alarm arrangement 50 may be used with the analog timepiece embodied as an analog clock or an analog watch. Accordingly, the alarm arrangement 50 comprises an alarm control panel 51 provided on the casing 10, an alarm speaker 52 provided on the casing 10 for delivering alarm signal, and an alarm control module 53 electrically incorporated with the control processor 411 for controlling the operation of the alarm speaker 52. The alarm arrangement 50 can have more than one alarm setting. This example shows two alarm settings for the analog timepiece as an alarm wall clock.

The alarm control panel 51 may have two positions for indicating two separate alarm settings. When the user operates the alarm control panel 51, one of the predetermined time indicators 200, such as the second indicating hand 21 of the first time indicator 200, is driven to fast spin to show the current alarm hour by pointing at a particular position on the time chart 13. The user is then able to adjust the alarm hour by operating the alarm control panel 51. Similarly, the minute setting of the alarm can be shown and adjusted in the similar fashion as the hour alarm setting. Thus, when the user operates the alarm control panel 51, one of predetermined time indicators 200, such as the second indicating hand 21 of the first time indicator 200, is driven to fast spin to show the current alarm hour by pointing at a particular position on the time chart 13. Moreover, one of the time indicators 200 is arranged to indicate the morning or afternoon setting of the alarm because there is an internal time keeping of the perpetual calendar arrangement 40 as described above. Therefore, morning and afternoon settings become necessary.

It is important to mention that since the alarm preset by the user operates against the internally kept time stored in the perpetual control unit 41, the time at which the alarm signal is delivered (i.e. the alarm setting) therefore directly corresponds to a real-time as synchronized by the perpetual calendar arrangement 40. This resolves the traditional problem of having an alarm signal at an undesirable or inaccurate time when the time of the traditional clock or watch has not been properly adjusted or set with respect to actual time. For example, when the user improperly or inadvertently set the time of a clock to be one hour in advance of the actual time, and then set an alarm time, the alarm signal will therefore be delivered at a wrong time (i.e. one hour in advance of the actual desirable alarm time).

To adjust AM/PM setting, the user needs to operate the alarm control panel 51 so that the corresponding time indicators 200 are driven to stop at one of two predetermined positions representing morning and afternoon respectively. Then, the user may be able to adjust the setting by operating the alarm control panel 51.

Once the alarm is set, the alarm speaker 52 is arranged to generate a predetermined audible sound when the current time coincides with the alarm setting. The alarm speaker 52 may generate “Beep” sound or any other sounds to alert the user of the present invention.

It is important to mention that the first through six time indicators 200 can take a number of alternatives for indicating time. These alternatives are typical for conventional timepiece. For example, some of the first through sixth time indicators 200 may be embodied as comprising purely indicating hands, or a combination of indicating hands and indicator discs for displaying the relevant second information, hour information, minute information, day information, month information and year information. Note also that not all of these pieces of information are necessarily present in the particular embodiment of the present invention. For example, based on market needs and product design requirement, the present may need to comprise only first through fourth time indicators indicating only the hour information, minute information, day information and month information. For other particular embodiments of the present invention, all six items of information may be necessary. The subject matter of the present invention is to allow at least one of these time indicators 200 for setting a perpetual calendar which facilitates internal timekeeping.

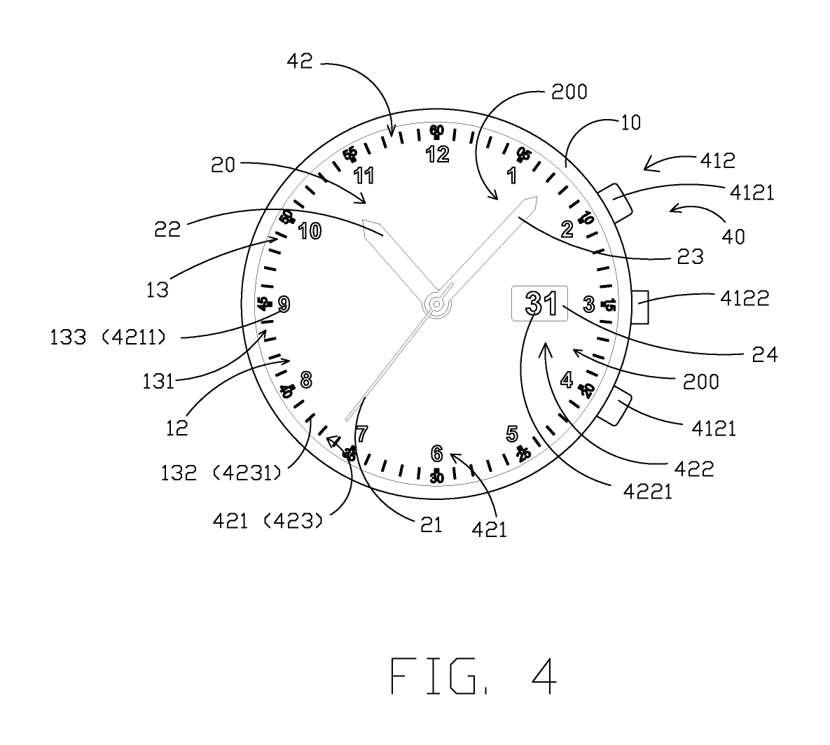

Referring to FIG. 4 of the drawings, a first alternative mode of the analog timepiece according to the preferred embodiment of the present invention is illustrated. The first alternative mode is similar to the preferred embodiment, except the analog timepiece further comprises at least a fourth time indicator 200 for indicating day information, wherein the fourth time indicator 200 comprises a day disc 24. This is utilized for indicating the day information. In other words, the analog timepiece of the present invention no longer uses one of the first through third time indicator 200 for indicating the day information. Rather, the day disc 24 is used for indicating the day information.

According to first alternative mode, the day indicator 422 is provided on the day disc 24. The day indicator 422 contains a plurality of day markers 4221 spacedly and evenly formed on the day indicator 422. The day markers 4221 include the number “1” to “31” shown to the user according to the actual day of a particular period of time. For example, for May 31st, the day marker 4221 will show “31” on the day disc 24, as shown in FIG. 4 of the drawings.

For perpetual calendar operation, when the current day is 28th February, the day disc 24 will show “28”. On the next day, (i.e. March 1st), the day disc 24 will show “1”. As this invention has an internal real time clock, the perpetual control unit 41 is preset to adjust the date after February 28th to March 1st, and the perpetual control unit 41 is arranged to drive the corresponding time indicators 200, such as the second indicating hand 21 of the first time indicator 200 to advance 24×3 hours in order to advance the day disc 24 from February 28th to March 1st. So, the perpetual control unit 41 needs to drive the corresponding time indicator 200 (such as the day indicating hand 24 of the fourth time indicator 200) to advance sequentially day after another.

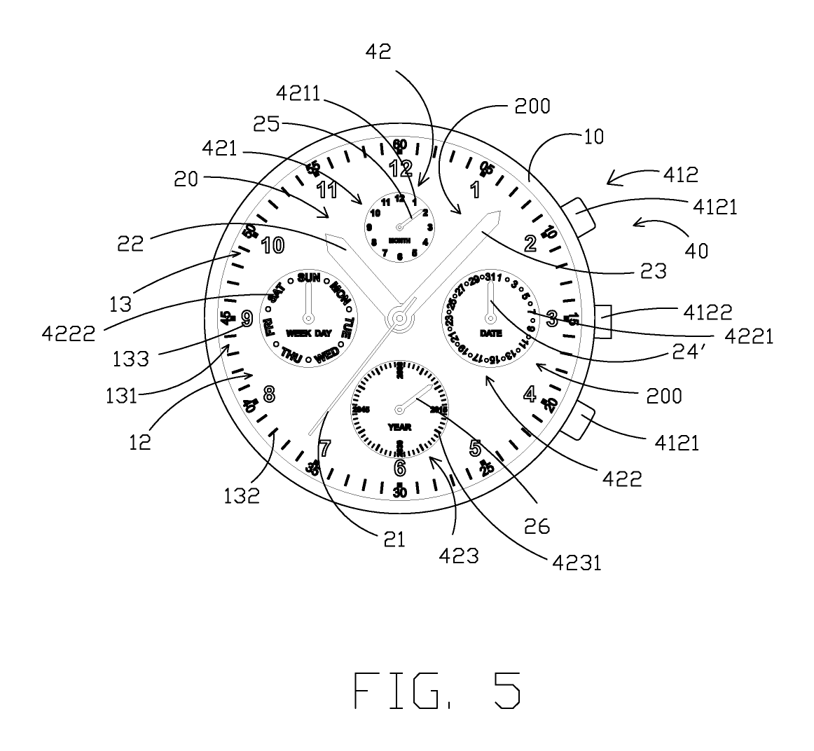

Referring to FIG. 5 of the drawings, a second alternative mode of the analog timepiece according to the preferred embodiment of the present invention is illustrated. The second alternative mode is similar to the preferred embodiment, except the analog timepiece further comprises at least one of fourth through seventh time indicators 200, wherein the fourth time indicator 200 comprises a day indicating hand 24′, the fifth time indicator 200 comprises a month indicating hand 25, the sixth time indicator 200 comprises a year indicating hand 26, and the seventh time indicator 200 comprises a weekday indicating hand 27. These are utilized for indicating the day information, month information, year information and the weekday information respectively. In other words, the analog timepiece of the present invention no longer uses the first through third time indicator 200 for indicating the day information, the month information, and the year information.

According to second alternative mode, the month indicator 421, the day indicator 422, and the year indicator 423 are provided on the month indicating hand 25, the day indicating hand 24′ and the year indicating hand 26 respectively. The day indicator 422 contains a plurality of day markers 4221 spacedly and evenly formed day indicator 422. The month indicator 421 contains a plurality (preferably twelve) month markers 4211 spacedly and evenly formed on the month indicating hand 25. The year indicator 423 contains a plurality (preferably twelve) month markers 4231 spacedly and evenly formed on the year indicating hand 26. Moreover, the day indicator 422 contains a plurality of weekday markers 4222 formed on the weekday indicating hand 27 for indicating the days of a week.

The weekday markers 422 therefore contain seven marks, namely Monday, Tuesday, Wednesday, Thursday, Friday, Saturday and Sunday. As shown in the above preferred embodiment, when one of the first through third time indicators 200 art used for weekday setup, seven predetermined positions can be assigned on the time chart 13 to indicate weekday information, and the weekday markers 4222 coincide with the second/minute marker 132 or the hour marker 133. For example, Monday marker 4222 can be formed at a position aligning 12:00:05 (a designated second/minute marker 132), while Tuesday marker 4222 can be formed at a position aligning 12:00:10, so on and so forth (i.e. 12:00:15 as Wednesday, 12:00:20 as Thursday, 12:00:25 as Friday, 12:00:30 as Saturday, 12:00:35 as Sunday). Accordingly, the seven predetermined positions can be assigned on the movement of the second indicating hand 21 to indicate weekday information, so that the corresponding time indicator 200 (such as the second indicating hand 21 of the first time indicator 200) is arranged to be driven to move to the corresponding positions on the time chart 13 to point to the corresponding weekday marker 4222 for illustrating the corresponding weekday. When fourth through seventh time indicators 200 are utilized, the weekday markers 4222 can be separately provided on the time chart 13 for indicating weekday information, as shown in FIG. 5 of the drawings.

However, the calendar setup may also be performed by one of the fourth through sixth time indicators 200, the month indicator 421, the day indicator 422, and the year indicator 423 are separately formed on the time chart 13 so that a user may setup the calendar by referencing to the corresponding the month indicator 421, the day indicator 422, and the year indicator 423. The procedures mentioned in the preferred embodiment above can then be simplified by directly adjusting the fourth through sixth time indicators 200 without, for example, aligning two of the first through third time indicators 200. In this first alternative mode, the day information, the month information, the year information and the weekday information are directly shown by the fourth through seventh time indicators 200 without requiring assigning specific positions on the second/minute markers 132 or the hour marker 133.

As a third alternative mode of the analog timepiece according to the preferred embodiment of the present invention, it is similar to the preferred embodiment except the procedures for internal time setup for allowing the perpetual control unit 41 to maintain the current time of the location in which the watch operates.

In this third alternative mode, after the current time has been set as described in the preferred embodiment above, the user needs to push the actuating stem 4122 back to its original position. The perceptual control unit 41 is then arranged to drive the predetermined time indicator 200 (such as the second indicating hand 21 of the first time indicator 200) to spin on the time chart 13 and pause at a predetermined home position (e.g. 12 o'clock position) for a predetermined period of time (e.g. 3 seconds) and then stops at another predetermined position (e.g. 1 o'clock) if there is no timekeeping within the perpetual control unit 41, and that predetermined time indicator 200 (such as the second indicating hand 21 of the first time indicator 200) will be driven to stop at the current hour position if timekeeping has been set up (for example, the internal timekeeping is 4:12 pm, the second indicating hand will stop at 4 o'clock position that is 20 steps from 12 o'clock home position). When the internal timekeeping has not been set up, the user needs to actuate one of the predetermined actuating buttons 4121 to bring the predetermined time indicator 200 (such as the second indicating hand 21 of the first time indicator 200) to stop at the current time (e.g. 3 o'clock). The user then has to actuate one of the predetermined buttons 4121 to confirm and end the hour setting.

For minute setup, if the current time is 3:30 pm, the second indicating hand 21 should be thirty steps from 12 o'clock position. Since there are sixty minutes around the time chart 13, therefore, each step of the second indicating hand 21 equals one minute. Thirty steps equal to thirty minute. The user needs to actuating one of the actuating buttons 4121 to bring the second indicating hand 21 to align with the minute indicating hand 23, and when the second indicating hand 21 is brought to align with the minute indicating hand 23, the user needs to actuate one of the actuating buttons 4121 to confirm the alignment and end the minute setting. The advantage of this method is that user can set the hour easier and more straightforwardly. However, there is no minute information when setting hour, so user must set minute independently.

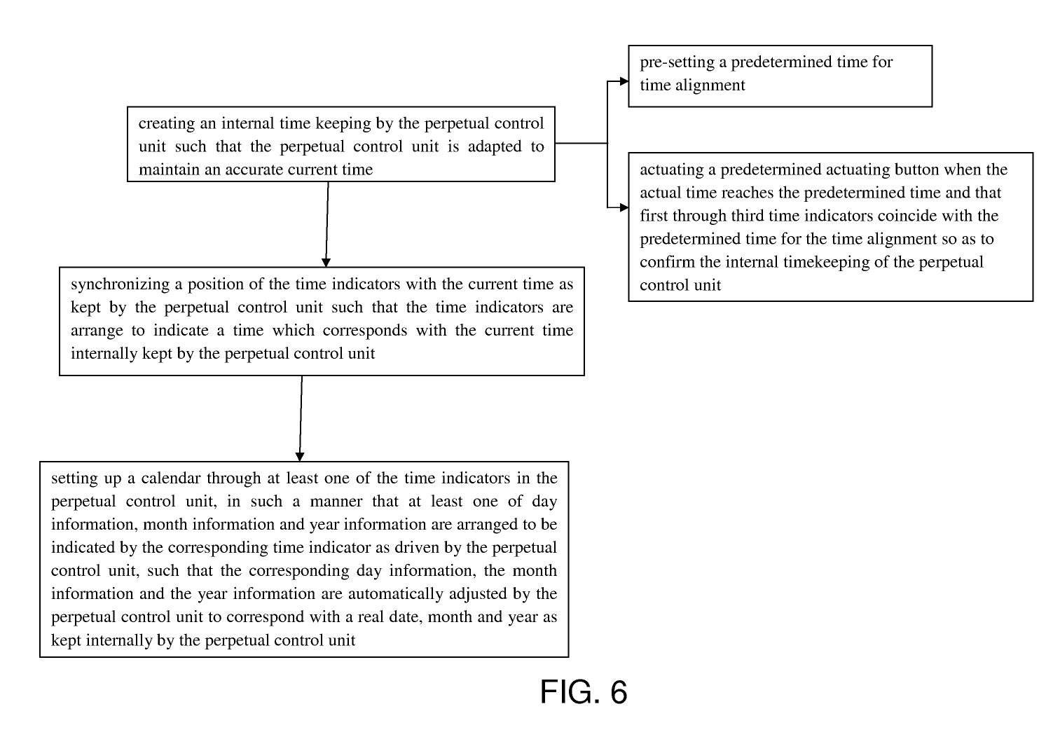

Referring to FIG. 6 of the drawings, a fourth alternative mode of the watch according to the preferred embodiment of the present invention is illustrated. The second alternative mode is similar to the preferred embodiment except the procedures for internal time setup for allowing the perpetual control unit 41 to maintain the current time of the location in which the watch operates. According to the third alternative mode, the perpetual control unit 41 is pre-programmed to have a predetermined time for time alignment (e.g. 3:00:00 pm). For example, when the actual time is 3:00:00 pm and the first through third time indicators 200 pause at the corresponding position of 3:00:00 pm on the time chart 13, the user needs to actuate one of the actuating buttons 4121 once to confirm an internal timekeeping of the perpetual control unit 41.

In other words, step (a) comprises the steps of:

(a.1′) pre-setting a predetermined time for time alignment;

(a.2′) actuating a predetermined actuating button 4121 when the actual time reaches said predetermined time and that first through third time indicators 200 coincide with the predetermined time for the time alignment so as to confirm the internal timekeeping of the perpetual control unit 41.

It is worth mentioning that the adjustment of time and the operation of the perpetual calendar may vary without violating the spirit of the present invention. In particular, illustration of the perceptual calendar may also be accomplished through fourth through sixth time indicators 200, which comprises a day indicating hand 24, a month indicating hand 25 and a year indicating hand 26 respectively (these indicating hands 24, 25, 26 are collectively termed as calendar hands hereinafter). Note, however, that the fourth through sixth time indicators 200 may only be used to indicate perceptual calendar. As a general description, for a timepiece having the day indicating hand 24, the month indicating hand 25 and the year indicating hand 26, when the current time is 28th February, the day indicating hand 24 will show “28”. On the next day, (i.e. March 1st), the day indicating hand 24 will show “1”. As this invention has an internal real time clock, the perpetual control unit is preset to adjust the date after February 28th to March 1st, and the perpetual control unit 41 is arranged to drive the day indicating hand 24 to advance 24×2 hours in order to advance the day indicating hand 24 from February 28th to March 1st. So, the perpetual control unit 41 needs to drive the corresponding time indicator 200 (such as the day indicating hand 24 of the fourth time indicator 200) to advance sequentially day after another. Furthermore, there may also be a seventh time indicator 200 comprising a weekday indicating hand 27 for indicating weekday information. The following occasions are anticipated:

Occasion 1: Timepiece with Single Rotor and with the Calendar Hand

Some or all of the fourth through sixth time indicators 200 is driven by some or all of the first through third time indicators 200. In this occasion, the day indicating hand 24 is driven by the hour indicating hand 22, while the hour indicating hand 22 is driven by the minute indicating hand 23 and the minute indicating hand 23 is driven by second indicating hand 21 so the fourth through sixth time indicators 200 are driven in a sequential manner by the first through third time indicator 200. For instances, from February-28 to March-1, the second indicating hand 21 needs to drive the minute indicating hand 23 to advance the hour indicating hand 22 by 24×3 hour in order to advance the day indicating hand 24 from 28 to 29 to 30 to 31 and then to 1^{st} of March. By doing so the second indicating hand 21 needs to rotate 24×3×60 (i.e. 4320) turns. It is because for the second indicating hand 21 to advance one hour, the second indicating hand 21 needs to rotate 60 turns.

Occasion 2: Timepiece with Dual Rotors and with the Calendar Hand

At least one of the fourth through sixth time indicators 200 is driven by the a corresponding first through third time indicator 200 (such as the hour indicating hand 22 of the second time indicator 200), while the hour indicating hand 22 is driven by minute indicating hand 23, so that the corresponding fourth through sixth time indicator (such as the day indicating hand 24) is driven in a sequential manner by the minute indicating hand 23. For instant from February-28 to March-1, the minute indicating hand 23 needs to drive the hour indicating hand 22 to advance by 24×3 hour in order to advance the calendar indication from 28 to 29 to 30 to 31 and then to 1^{st} of March. By doing so the minute indicating hand 23 needs to rotate 24×3 (72) turns. Compared with 24×3×60 (4,320) turns in occasion 1, the watch will save a lot of battery power when dual rotors are used for the perpetual calendar application. It is because to advance one hour the minute indicating hand 23 only needs to rotate 1 turn.

Occasion 3: Timepiece with Multiple Rotors and without any Calendar Hand

In this occasion, one of the rotors is used to drive one of the time indicators 200 to show day information, month information and/or year information. So, from February-28 to March-1, the corresponding time indicators 200 just points from 28 to 1 without advance for 24×3 hours. This is similar to the preferred embodiment described above.

Occasion 4: Timepiece with Multiple Rotors and with Calendar Hands

The calendar hands are driven by the one of the first through third time indicators 200, such as the hour indicating hand 22 of the second time indictor 200 in this scenario. The hour indicating hand 22 is driven by the minute indicating hand 23 and the minute indicating hand 23 is driven by the second indicating hand 21 so that one of the calendar hands (i.e. one of the fourth through sixth time indicators 200) is driven to move in a sequential manner by the second indicating hand 21. For instances, from February-28 to March-1, the second indicating hand 21 needs to drive the minute indicating hand 23 to advance the hour indicating hand 22 by 24×3 hour in order to advance the one of the calendar hands (such as the day indicating hand 24) from 28 to 29 to 30 to 31 and then to 1st of March. By doing so the second indicating hand 21 needs to rotate 24×3×60 (4320) turns. It is because for the second indicating hand 21 to advance one hour the second indicating hand 21 needs to rotate 60 turns.

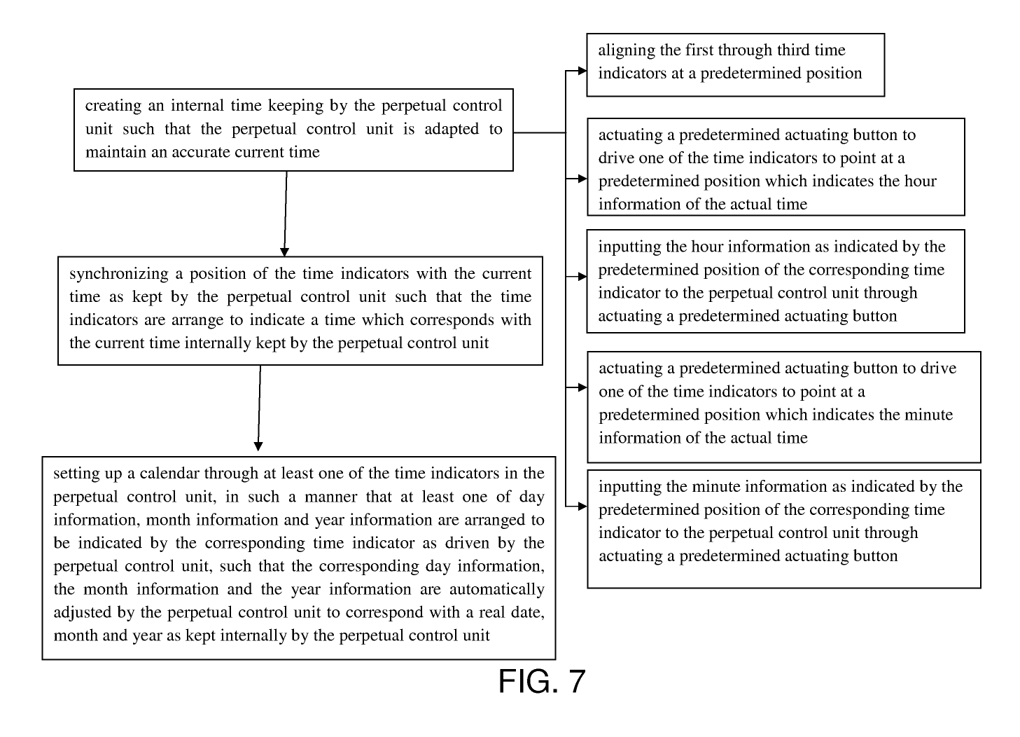

Referring to FIG. 7, a fifth alternative mode of the present invention is similar to the preferred embodiment except that this fifth alternative mode uses the second indicating hand 21, for example, to point at time chart 13 to input/set up time-keeping. With this method, the hour and minute indicating hands 22, 23 must align to a predetermined position example 12:00:00. The second indicating hand 21 is driven from it predetermined position example 12:00:00 position to point at the time chart 13. For instant, the time now is 3:30 pm. First of all, the user need to set second, hour and minute indicating hands 21, 22, 23 to a predetermined position (such as 12:00:00), and the user is pressing a predetermined actuating button 4121 to drive the second indicating hand 21 to point at 3:00 position and press another button to confirm. By doing so, the 3:00 is input into the perpetual control unit 41. Then user drives the second indicating hand 21 to point at 00:30 position and press another actuating button 4121 to input. Now 3:30 is input into the perpetual control unit 41. As all hands are located at 12:00:00 before the time-keeping input operation so the perpetual control unit 41 knows the hands' position. After time is set in the perpetual control unit 41, the perpetual control unit 21 is arranged to generate pulse to drive the hands 21, 22, 23 running to match the time set up in the perpetual control unit 41.

Thus, step (a) comprises the steps of:

(a.1″) aligning the first through third time indicators 200 at a predetermined position;

(a.2″) actuating a predetermined actuating button 4121 to drive one of the time indicators 200 to point at a predetermined position which indicates the hour information of the actual time;

(a.3″) inputting the hour information as indicated by the predetermined position of the corresponding time indicator 200 to the perpetual control unit 41 through actuating a predetermined actuating button 4121;

(a.4″) actuating a predetermined actuating button 4121 to drive one of the time indicators 200 to point at a predetermined position which indicates the minute information of the actual time; and

(a.5″) inputting the minute information as indicated by the predetermined position of the corresponding time indicator 200 to the perpetual control unit 41 through actuating a predetermined actuating button.

One skilled in the art will understand that the embodiment of the present invention as shown in the drawings and described above is meant to be illustrative only and should not be limited as such. From the forgoing descriptions, it can be demonstrated that the objects of the present invention have been fully and effectively accomplished. The embodiments have been shown and described for the purposes of illustrating the core patentable subject matter of the present invention and is subject to change without departure from the core spirit of the present invention.

1. An analog timepiece, comprising:
a casing having a receiving cavity and a display window for visually communicating said receiving cavity with an exterior of said casing;
a time indicating device provided on said casing for indicating time information including at least one of second information, hour information and minute information, and date information including at least one of day information, weekday information, month information and year information; and
a perpetual calendar arrangement, which comprises:
a perpetual control unit which is arranged to create an internal time keeping such that said perpetual control unit is adapted to maintain an accurate current time and date, wherein said time indicating device is synchronized with said current time and date as maintained by said perpetual control unit so that said time indicating device is arranged to indicate a time which corresponds with said time internally kept by said perpetual control unit, wherein said perpetual control unit is arranged to display at least one of day information, month information, year information and weekday by said time indicating device, in such a manner that said corresponding day information, said weekday information, said month information and said year information are automatically adjusted according to said time internally maintained through said perpetual control unit, so that a user needs not manually adjust date, month and year indication on said timepiece.

2. The analog timepiece, as recited in claim 1, wherein said time indicating device comprises at least one of first through third time indicators for indicating the time and date information of a particular moment, wherein said first through third time indicators comprises a second indicating hand, a hour indicating hand, and an minute indicating hand respectively, wherein said second indicating hand, said hour indicating hand, and said minute indicating hand are movably supported by said casing within said receiving cavity.

3. The analog timepiece, as recited in claim 2, wherein said perpetual control unit comprises a control processor and a plurality of actuators provided on said casing to drive said time indicators to predetermined positions for accomplishing an internal time keeping and synchronization of said perpetual calendar arrangement with respect to an actual time, wherein each of said actuators comprises at least one actuating button provided on said casing to mechanically communicate with said control processor and said time indicators to adjust positions of said corresponding time indicators and to control said internal timekeeping and said synchronization process.

4. The analog timepiece, as recited in claim 3, wherein said control processor of said perpetual control unit is pre-programmed to switch time and calendar display for different time zones upon initial setup of said initial time and said date information for each of said different time zones.

5. The analog timepiece, as recited in claim 3, wherein said perpetual control unit is pre-programmed to respond to a single actuation of a single predetermined actuating button by discretely and sequentially drive said corresponding time indicator to show at least one of day information, weekday information, month information and year information.

6. The analog timepiece, as recited in claim 4, wherein said perpetual control unit is pre-programmed to respond to a single actuation of a single predetermined actuating button by discretely and sequentially drive said corresponding time indicator to show at least one of day information, weekday information, month information and year information.

7. The analog timepiece, as recited in claim 2, wherein said time indicating device further comprises at least one of fourth through seventh time indicators comprising at least one of a day indicating hand, a indicating month hand, a year indicating hand and a weekday indicating hand respectively for indicating said second information, said hour information, said minute information, and said weekday information respectively as internally kept by perpetual control unit.

8. The analog timepiece, as recited in claim 4, wherein said time indicating device further comprises at least one of fourth through seventh time indicators comprising at least one of a day indicating hand, a month indicating hand, a year indicating hand and a weekday indicating hand respectively for indicating said second information, said hour information, said minute information, and said weekday information respectively as internally kept by perpetual control unit.

9. The analog timepiece, as recited in claim 6, wherein said time indicating device further comprises at least one of fourth through seventh time indicators comprising at least one of a day indicating hand, a month indicating hand, a year indicating hand and a weekday indicating hand respectively for indicating said second information, said hour information, said minute information, and said weekday information respectively as internally kept by perpetual control unit.

10. The analog timepiece, as recited in claim 2, wherein said time indicating device further comprises at least a fourth time indicator comprising at least one a day disc for indicating said day information as internally kept by perpetual control unit.

11. The analog timepiece, as recited in claim 4, wherein said time indicating device further comprises at least a fourth time indicator comprising at least one a day disc for indicating said day information as internally kept by perpetual control unit.

12. The analog timepiece, as recited in claim 6, wherein said time indicating device further comprises at least a fourth time indicator comprising at least one a day disc for indicating said day information as internally kept by perpetual control unit.

13. The analog timepiece, as recited in claim 2, further comprising an alarm arrangement which comprises an alarm control panel provided on said casing, an alarm speaker provided on said casing for delivering an alarm signal, and an alarm control module electrically incorporated with said control processor for controlling an operation of said alarm speaker when said internally kept time reaches said preset alarm time.

14. The analog timepiece, as recited in claim 9, further comprising an alarm arrangement which comprises an alarm control panel provided on said casing, an alarm speaker provided on said casing for delivering an alarm signal, and an alarm control module electrically incorporated with said control processor for controlling an operation of said alarm speaker when said internally kept time reaches said preset alarm time.

15. The analog timepiece, as recited in claim 12, further comprising an alarm arrangement which comprises an alarm control panel provided on said casing, an alarm speaker provided on said casing for delivering an alarm signal, and an alarm control module electrically incorporated with said control processor for controlling an operation of said alarm speaker when said internally kept time reaches said preset alarm time.

16. The analog timepiece, as recited in claim 13, wherein said alarm control panel is arranged to allow a user to set alarm setting through at least one of said time indicators moving in said casing.

17. The analog timepiece, as recited in claim 14, wherein said alarm control panel is arranged to allow a user to set alarm setting through at least one of said time indicators moving in said casing.

18. The analog timepiece, as recited in claim 15, wherein said alarm control panel is arranged to allow a user to set alarm setting through at least one of said time indicators moving in said casing.

19. The analog timepiece, as recited in claim 9, wherein said perpetual calendar arrangement is arranged to operate automatic adjustment of date information in the following manner:
(i) for a particular month having thirty one days, said corresponding time indicator is arranged to show “31” as the last day of said particular month;
(ii) for a particular month having thirty days, said perpetual control unit is arranged to drive said corresponding time indicator to advance for twenty four hours so as to adjust said day information to skip “31” illustration at the end of thirtieth day of said particular month;
(iii) for a particular month having twenty eight days, said perpetual control unit is arranged to drive said corresponding time indicator to advance for seventy two hours to adjust said day information to skip the “29”, “30” and “31” illustration at the end of said twenty eighth day of said particular month; and
(iv) for a particular month with twenty nine days, said perpetual control unit is arranged to drive said corresponding time indicator to advance for forty eight hours to adjust said day information to skip “30” and “31” illustration at the end of the twenty ninth of said particular month.

20. The analog timepiece, as recited in claim 12, wherein said perpetual calendar arrangement is arranged to operate automatic adjustment of date information in the following manner:
(i) for a particular month having thirty one days, said corresponding time indicator is arranged to show “31” as the last day of said particular month;
(ii) for a particular month having thirty days, said perpetual control unit is arranged to drive said corresponding time indicator to advance for twenty four hours so as to adjust said day information to skip “31” illustration at the end of thirtieth day of said particular month;
(iii) for a particular month having twenty eight days, said perpetual control unit is arranged to drive said corresponding time indicator to advance for seventy two hours to adjust said day information to skip the “29”, “30” and “31” illustration at the end of said twenty eighth day of said particular month; and
(iv) for a particular month with twenty nine days, said perpetual control unit is arranged to drive said corresponding time indicator to advance for forty eight hours to adjust said day information to skip “30” and “31” illustration at the end of the twenty ninth of said particular month.
